(19) United States
(12) Patent Application Publication
(10) Pub. No.: US 2026/0134059 A1
(43) Pub. Date: May 14, 2026

(54) UPDATING PROJECTION MATRIX AT GRADIENT DESCENT OPTIMIZER

(71) Applicant: Lemon Inc., Grand Cayman (KY)

(72) Inventors: Shen Sang, Los Angeles, CA (US); Jinqi Xiao, Los Angeles, CA (US); Tiancheng Zhi, Los Angeles, CA (US); Jing Liu, Los Angeles, CA (US); Qing Yan, Los Angeles, CA (US); Linjie Luo, Los Angeles, CA (US)

(21) Appl. No.: 18/942,157

(22) Filed: Nov. 8, 2024

(51) Int. Cl. G06F 17/18; G06F 17/16; G06N 3/08

(52) U.S. Cl. CPC G06F 17/18; G06F 17/16; G06N 3/08

(57) ABSTRACT

A computing system including one or more processing devices configured to receive a weight tensor of a neural network. The one or more processing devices are further configured to execute a gradient descent optimizer that updates the weight tensor over a plurality of projection matrix update intervals. Each of the projection matrix update intervals includes computing a gradient over the weight tensor in each of a plurality of gradient descent iterations. Each of the gradient descent iterations further includes projecting the gradient into a reduced-rank subspace using a projection matrix and updating the weight tensor by performing gradient descent using the projected gradient. Each of the projection matrix update intervals further includes computing a projection matrix error value associated with the projection matrix and updating the projection matrix based at least in part on the projection matrix error value.

### BACKGROUND

Gradient descent is the primary technique by which deep neural network training is performed. When gradient descent is performed, training input data is passed through the neural network, and a value of a loss function or reward function is computed based on the result of processing that training input data at the neural network. A gradient descent optimizer is then executed to modify the parameters of the neural network based on the value of the loss function or reward function. The gradient descent optimizer estimates a gradient of the parameters of the neural network with respect to the loss function or reward function. The gradient descent optimizer estimates gradients at different layers of the neural network by performing backpropagation through those layers. For each of the layers, the gradient descent optimizer uses the estimated gradient to compute an update to the parameters included in that layer of the neural network. Thus, the neural network is trained according to the loss value or reward value it achieves for its result of processing the training input data.

When updating the parameters of a neural network, gradient descent optimizers typically compute a first-order momentum term and a second-order momentum term associated with the gradient. These momentum terms frequently require large amounts of memory to store when conventional neural network training techniques are used. In examples in which graphics processing units (GPUs) are used to perform gradient descent, the combined size of the gradient, first-order momentum term, and second-order momentum term may exceed the memory capacity of a GPU. For example, training a 7-billion-parameter LLAVA model may require approximately 56 GB of memory to store the optimizer states. Increasing the batch size of the training data or adding more information beyond the gradient and momentum terms to the optimizer states further increases the memory usage.

### SUMMARY

According to one aspect of the present disclosure, a computing system is provided, including one or more processing devices configured to receive a weight tensor of a neural network. The one or more processing devices are further configured to execute a gradient descent optimizer that updates the weight tensor over a plurality of projection matrix update intervals. Each of the projection matrix update intervals includes computing a gradient over the weight tensor in each of a plurality of gradient descent iterations included in the projection matrix update interval. Each of the gradient descent iterations further includes projecting the gradient into a reduced-rank subspace using a projection matrix and updating the weight tensor by performing gradient descent using the projected gradient. Each of the projection matrix update intervals further includes computing a projection matrix error value associated with the projection matrix. Each of the projection matrix update intervals further includes updating the projection matrix based at least in part on the projection matrix error value.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example computing system that includes one or more processing devices at which a gradient descent optimizer is executed, according to one example embodiment.

FIG. 2 schematically shows the computing system in additional detail when an update to a weight tensor is computed at the gradient descent optimizer, according to the example of FIG. 1.

FIG. 3 schematically shows the computing system when the one or more processing devices are configured to update a projection matrix, according to the example of FIG. 2.

FIG. 4 shows an example timeline of training performed on the weight tensor, according to the example of FIG. 3.

FIG. 5 schematically shows the computing system when the one or more processing devices are configured to recompute the projection matrix, according to the example of FIG. 1.

FIG. 6 shows pseudocode of an algorithm by which the weight tensor may be updated to train the neural network, according to the example of FIG. 1.

FIG. 7 schematically shows the computing system in an example in which a weight tensor is included in a convolutional layer of the neural network, according to the example of FIG. 1.

FIG. 8 shows the computing system in additional detail when the one or more processing devices compute the updated weight tensor, according to the example of FIG. 7.

FIG. 9 schematically shows the computing system when the first projection matrix and the second projection matrix are updated, according to the example of FIG. 8.

FIG. 10A shows a flowchart of a method for use with a computing system when training a neural network, according to the example of FIG. 1.

FIGS. 10B-10D show additional steps of the method of FIG. 10A that may be performed in some examples.

FIG. 11 shows a schematic view of an example computing environment in which the computing system of FIG. 1 may be instantiated.

### DETAILED DESCRIPTION

In order to reduce the amount of memory used to store optimizer states when performing gradient descent, several previous solutions have been developed that utilize the low-rank structure of the gradient. By projecting the gradient into a reduced-rank subspace, the storage size of the gradient is decreased while preserving most of the structural features of the gradient. For example, Low-Rank Adaptation (LoRA) is a technique that has been used to reduce GPU memory consumption by applying low-rank updates to neural network parameters. GaLore is another approach in which singular value decomposition (SVD) is used to compute a low-rank projection matrix with which the gradient descent optimizer projects the gradient into a reduced-rank subspace. Another approach known as FLORA includes performing random projection on the gradient.

Existing techniques for reducing the memory requirements of gradient descent have shortcomings that limit their usability for some neural network training tasks. GaLore relies on SVD, which has a computational complexity of O(n³), where n is the dimension of the matrix on which SVD is performed. For machine learning models with large weight matrices, this computational complexity may significantly reduce training speed. The GaLore approach has also not been validated on computer vision models, such as those that make use of convolutional neural networks (CNNs). Instead, GaLore has primarily been validated on large language models (LLMs).

As another drawback of current training approaches, different batches of training data may exhibit substantial variability in gradient direction. As a result of this variability, the projection space specified by a projection matrix may deviate from the principal direction of the gradient, thereby reducing the convergence rate of the training process. Thus, existing techniques that use projection matrices may have low reliability when significant changes in gradient direction occur.

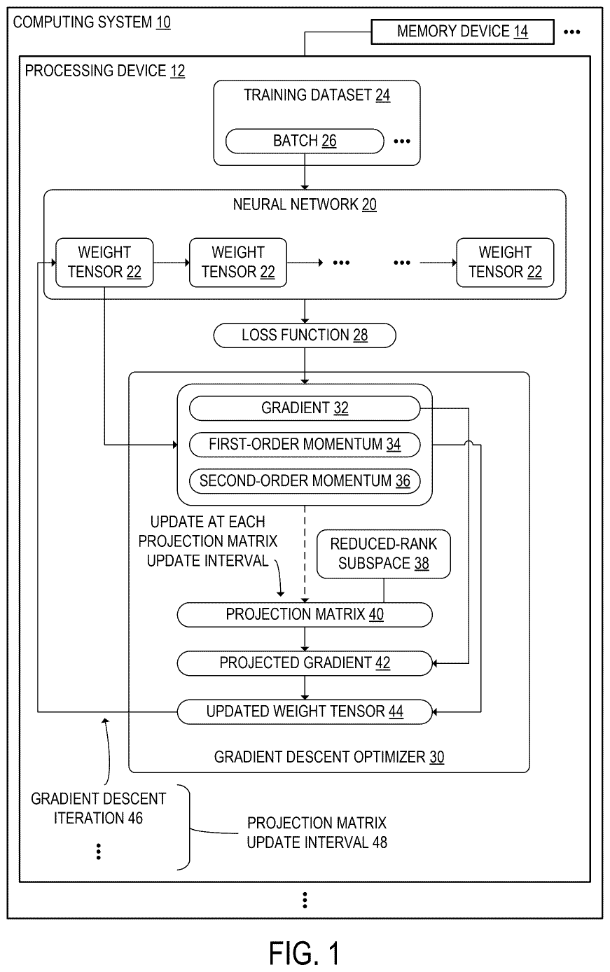

In order to address the above shortcomings of existing approaches to reducing memory consumption by gradient descent optimizers, a computing system 10 is provided as shown in the example of FIG. 1. FIG. 1 schematically shows an example computing system 10 that includes one or more processing devices 12 and one or more memory devices 14. The one or more processing devices 12 include one or more GPUs. Other types of processing devices 12, such as one or more central processing units (CPUs) or other hardware accelerators, may also be included in the computing system 10. The one or more memory devices 14 may include volatile memory and/or non-volatile storage. In some examples, the computing system 10 is provided in a single physical computing device, whereas in other examples, components of the computing system 10 are provided across a plurality of communicatively connected physical computing devices.

The one or more processing devices 12 are configured to receive a weight tensor 22 of a neural network 20. The neural network 20 shown in FIG. 1 includes a plurality of weight tensors 22 that form respective layers of the neural network 20. The weight tensor 22 may be received as a matrix in which the matrix elements are the weights of the neural network 20. In other examples, the weight tensor 22 may be a higher-dimensional tensor.

The one or more processing devices 12 are further configured to execute a gradient descent optimizer 30 that updates the weight tensor 22. For example, the gradient descent optimizer 30 may utilize Adam, AdamW, Adafactor, or some other gradient descent optimization algorithm, with the modifications discussed below. FIG. 1 shows the neural network 20 when the gradient descent optimizer 30 updates the weight tensor 22 included in a first layer of the neural network 20. However, the other weight tensors 22 of the neural network 20 may also be updated according to the approach shown in FIG. 1.

The one or more processing devices 12 are further configured to perform a plurality of gradient descent iterations 46. At each of the gradient descent iterations 46, the neural network 20 is configured to receive a batch 26 of training data included in a training dataset 24. The one or more processing devices 12 are further configured to perform a forward pass through the neural network 20 by processing the batch 26 of training data at the weight tensors 22. In some examples, such as when the neural network 20 is a mixture-of-experts (MoE) model, a subset of the weight tensors 22 may be used in the forward pass, rather than all the weight tensors 22 included in the neural network 20. The one or more processing devices 12 are further configured to compute a value of a loss function 28 based at least in part on a result of the forward pass. In other examples, a reward function may be used instead of a loss function. In examples in which a reward function is used, gradient ascent rather than gradient descent may be performed to train the neural network 20.

At the gradient descent optimizer 30, in each of the gradient descent iterations 46, the one or more processing devices 12 are further configured to compute a gradient 32 over the weight tensor 22. This gradient 32 is computed with respect to the loss function 28. In addition, the one or more processing devices 12 are further configured to compute a first-order momentum 34 and a second-order momentum 36 of the gradient 32.

At the gradient descent optimizer 30, the one or more processing devices 12 are further configured to project the gradient 32 into a reduced-rank subspace 38 using a projection matrix 40. This projection may be computed according to the following equation:

$${G}_{t}^{proj} = {G}_{t} {P}_{t}$$

In the above equation, t is the current gradient descent iteration 46, Gₜ is the gradient 32, and Pₜ is the projection matrix. The reduced-rank subspace 38 is a subspace of the tensor space in which the gradient 32 is included. In addition, the reduced-rank subspace 38 has a lower rank than the full rank of that tensor space. Accordingly, the one or more processing devices 12 are configured to compute a projected gradient 42. The projected gradient 42 may have a smaller size in memory than the full-rank gradient 32.

The one or more processing devices 12 are further configured to update the weight tensor 22 by performing gradient descent using the projected gradient 42. The one or more processing devices 12 are accordingly configured to train the neural network 20.

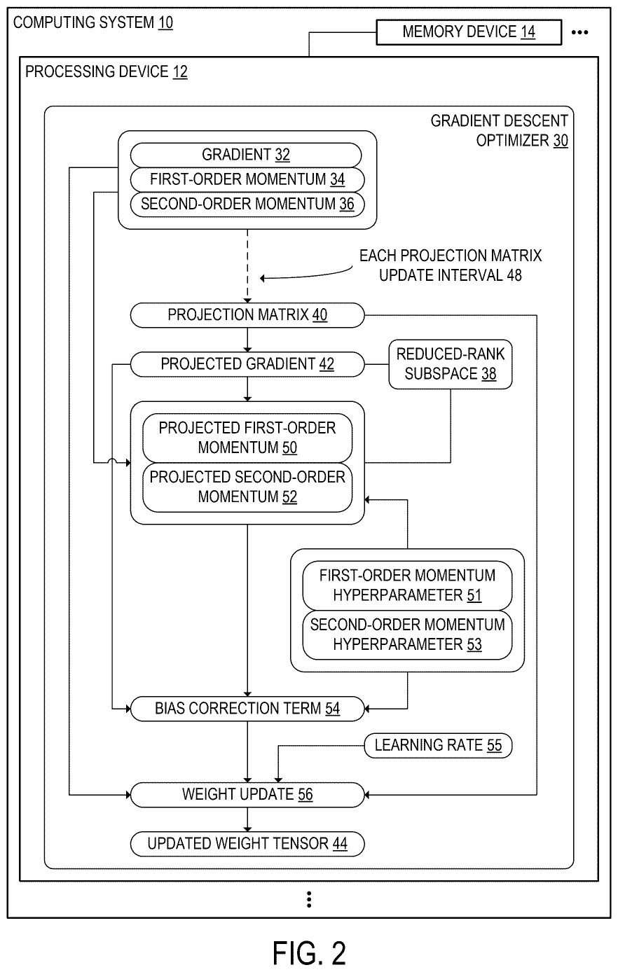

FIG. 2 schematically shows the computing system 10 in additional detail when the update to the weight tensor 22 is computed at the gradient descent optimizer 30. In the example of FIG. 2, the weight tensor 22, the gradient 32, the first-order momentum 34, and the second-order momentum 36 are matrices that respectively have dimensions W, Gₜ, Mₜ, Vₜ∈ [symbol] ^{m×n}, where t is the current gradient descent iteration 46.

At each of the gradient descent iterations 46, according to the example of FIG. 2, the one or more processing devices 12 are further configured to compute a projected first-order momentum 50 of the gradient 32 and a projected second-order momentum 52 of the gradient 32 based at least in part on the projected gradient 42. The projected first-order momentum 50 and the projected second-order momentum 52 are projected into the reduced-rank subspace 38. A first-order momentum hyperparameter 51 associated with the projected first-order momentum 50 and a second-order momentum hyperparameter 53 associated with the projected second-order momentum 52 are also used as inputs to the computation of the projected first-order momentum 50 and the projected second-order momentum 52, respectively.

The projected first-order momentum 50 may be computed according to the following equation:

$${M}_{t}^{proj} = {β}_{1} {M}_{t - 1}^{proj} + ( 1 - {β}_{1} ) {G}_{t}^{proj}$$

In the above equation, β₁ is the first-order momentum hyperparameter 51. Using the above equation, the one or more processing devices 12 are configured to iteratively update the projected first-order momentum 50 over the plurality of gradient descent iterations 46.

The projected second-order momentum 52 may be computed according to the following equation:

$${V}_{t}^{proj} = {β}_{2} {V}_{t - 1}^{proj} + ( 1 - {β}_{2} ) {( {G}_{t}^{proj} )}^{2}$$

In the above equation, β₂ is the second-order momentum hyperparameter 53. Using the above equation, the one or more processing devices 12 are configured to iteratively update the projected second-order momentum 52 over the plurality of gradient descent iterations 46.

The one or more processing devices 12 are further configured to update the weight tensor 22 based at least in part on the projected first-order momentum 50 and the projected second-order momentum 52. As shown in the example of FIG. 2, the one or more processing devices 12 are configured to compute a bias correction term 54 using the projected gradient 42, the projected first-order momentum 50, and the projected second-order momentum 52. The first-order momentum hyperparameter 51 and the second-order momentum hyperparameter 53 are also used as inputs to the computation of the bias correction term 54.

The one or more processing devices 12 may be configured to compute the bias correction term 54 according to the following equation:

$$Δ {W}_{t}^{proj} = \frac{{M}_{t}^{proj} / ( 1 - {β}_{1}^{t} )}{\sqrt{{V}_{t}^{proj} / ( 1 - {β}_{1}^{t} )} + ϵ}$$

In the above equation, ϵ is a constant term that is used to increase the numerical stability of updating the weight tensor 22.

The one or more processing devices 12 are further configured to compute a weight update 56 based at least in part on the bias correction term 54. For example, the one or more processing devices 12 may be configured to reproject the bias correction term 54 from the reduced-rank subspace 38 back into a full-rank space using the projection matrix 40 transposed. The one or more processing devices 12 may be further configured to multiply the result of that reprojection by a learning rate 55 to obtain the weight update 56. The one or more processing devices 12 are further configured to apply the weight update 56 to the weight tensor 22 to obtain the updated weight tensor 44.

The one or more processing devices 12 may be configured to compute the updated weight tensor according to the following equation:

$${W}_{t} = {W}_{t - 1} - η Δ {W}_{t}^{proj} {P}_{t}^{T}$$

In the above equation, η is the learning rate 55 and

$${P}_{t}^{T}$$

is the projection matrix 40 transposed.

In the example of FIG. 2, the bias correction term 54, the projected gradient 42, the projected first-order momentum 50, and the projected second-order momentum 52 are matrices that respectively have dimensions

$$Δ {W}_{t}^{proj} , {G}_{t}^{proj} , {M}_{t}^{proj} , {V}_{t}^{proj} ∈ {ℝ}^{m \times r} ,$$

where r is the rank of the reduced-rank subspace 38. Thus, the one or more processing devices 12 reduce the amount of memory used to store the bias correction term 54, the projected gradient 42, the projected first-order momentum 50, and the projected second-order momentum 52 by a factor of n/r.

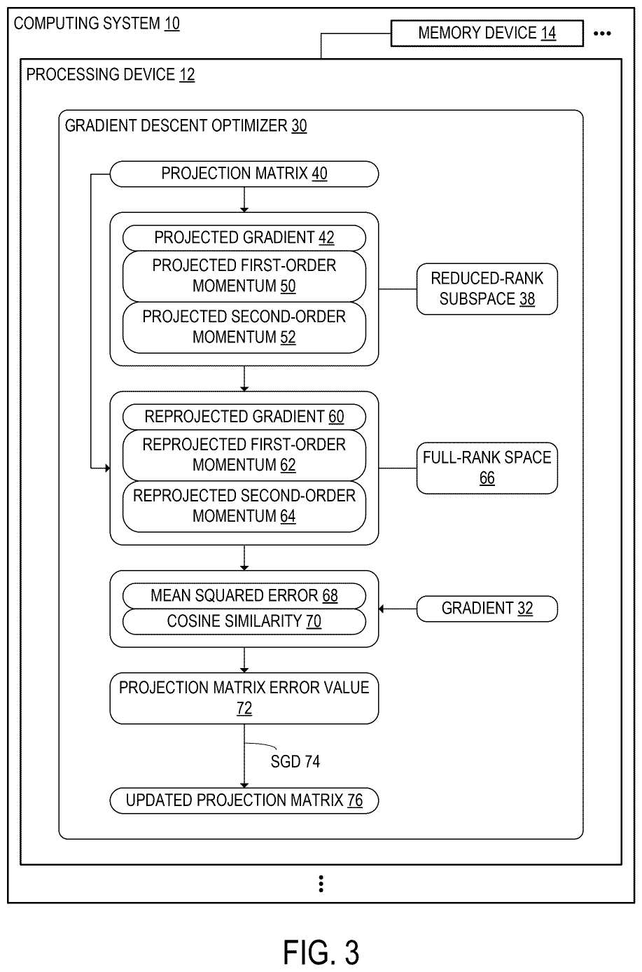

Returning to the example of FIG. 1, the one or more processing devices 12 are configured to update the weight tensor 22 over a plurality of projection matrix update intervals 48. Each of the projection matrix update intervals 48 includes a predefined number of gradient descent iterations 46. FIG. 3 schematically shows the computing system 10 when the one or more processing devices 12 are configured to update the projection matrix 40. Subsequently to performing the plurality of gradient descent iterations 46 included in a projection matrix update interval 48, the one or more processing devices 12 are further configured to compute a projection matrix error value 72 associated with the projection matrix 40. Based at least in part on the projection matrix error value 72, the one or more processing devices 12 are further configured to update the projection matrix 40 to obtain an updated projection matrix 76. For example, the one or more processing devices 12 may be configured to update the projection matrix 40 at least in part by performing stochastic gradient descent 74 on the projection matrix 40 with respect to the projection matrix error value 72.

When computing the projection matrix error value 72, the one or more processing devices 12 may be configured to reproject the projected gradient 42, the projected first-order momentum 50, and the projected second-order momentum 52 back into the full-rank space 66 from the reduced-rank subspace 38. Thus, the one or more processing devices 12 may be configured to compute a reprojected gradient 60, a reprojected first-order momentum 62, and a reprojected second-order momentum 64.

The one or more processing devices 12 may be further configured to compute a mean squared error 68 between the gradient 32 and the reprojected gradient 60. In addition, the one or more processing devices 12 may be further configured to compute a cosine similarity 70 between the reprojected first-order momentum 62 and the gradient 32. The one or more processing devices 12 may be further configured to compute the projection matrix error value 72 as the mean squared error 68 multiplied by one minus the cosine similarity 70. Thus, when the one or more processing devices 12 perform SGD over the projection matrix error value 72, the one or more processing devices may be configured to compute the following minimum:

$${min}_{{P}_{t}} MSE ( {\hat{G}}_{t} , {G}_{t} ) ( 1 - Cos Sim ( {\hat{M}}_{t - 1} , {G}_{t} ) )$$

In the above equation, t is the current gradient descent iteration, Pₜ is the projection matrix, Gₜ is the gradient, Ĝₜ is the reprojected gradient, and \hat{M}ₜ₋₁ is the reprojected first-order momentum 62 associated with a previous gradient descent iteration. The one or more processing devices 12 may be configured to update the projection matrix 40 according to the following equation:

$${P}_{t} = {P}_{t - 1} - \frac{\partial MSE ( {\hat{G}}_{t} , {G}_{t} )}{\partial {P}_{t - 1}} ( 1 - Cos Sim ( {\hat{M}}_{t - 1} , {G}_{t} ) ) + \frac{\partial Cos Sim ( {\hat{M}}_{t - 1} , {G}_{t} )}{\partial {P}_{t - 1}} MSE ( {\hat{G}}_{t} , {G}_{t} )$$

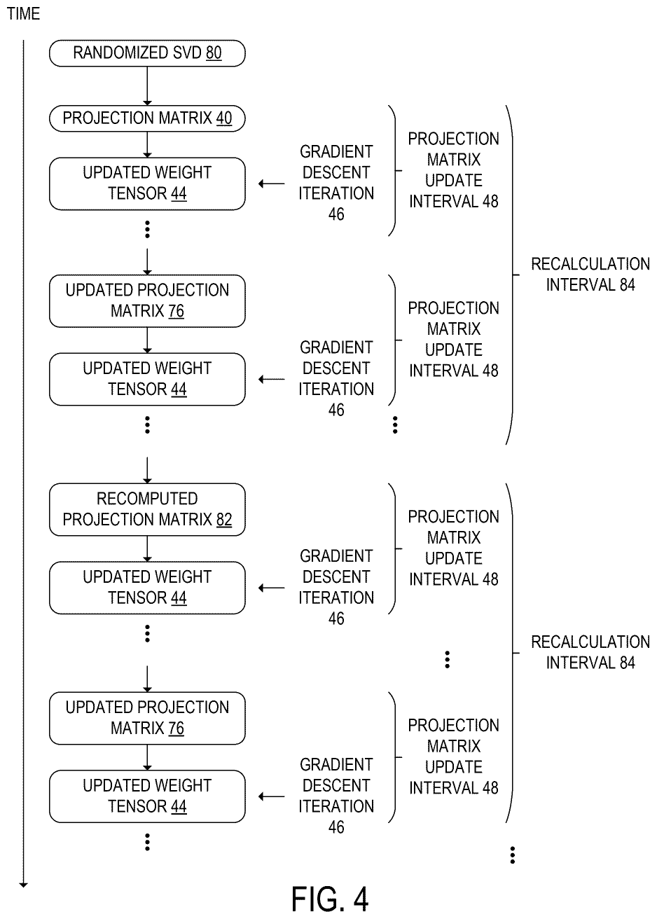

FIG. 4 shows an example timeline of training performed on the weight tensor 22. In this example, prior to the plurality of projection matrix update intervals 48, the one or more processing devices 12 are further configured to initialize the projection matrix 40 at least in part by performing randomized singular value decomposition (SVD) 80. Thus, the one or more processing devices 12 are configured to obtain the projection matrix 40 used in the first projection matrix update interval 48.

In the example of FIG. 4, the one or more processing devices 12 are further configured to recompute the projection matrix 40 at a recalculation interval 84. The recalculation interval 84 is a predefined number of the projection matrix update intervals 48. Accordingly, the one or more processing devices 12 are configured to compute a recomputed projection matrix 82 when the recalculation interval 84 has elapsed, and to use that recomputed projection matrix 82 when computing the updated weight tensor 44 in the gradient descent iterations 46 included in the following projection matrix update interval 48. When that projection matrix update interval 48 has elapsed, the one or more processing devices 12 are further configured to update the recomputed projection matrix 82 using the updating techniques discussed above.

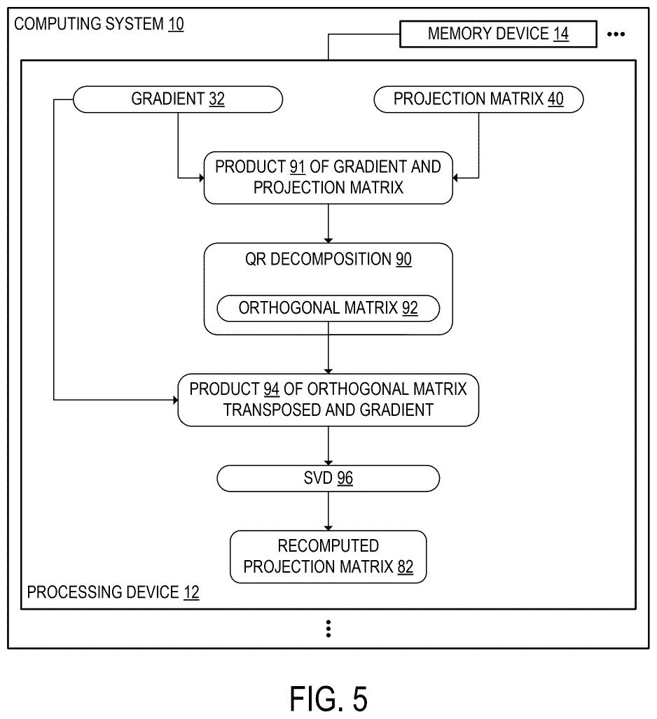

FIG. 5 schematically shows the computing system 10 when the one or more processing devices 12 are configured to recompute the projection matrix 40. The one or more processing devices 12 are configured to recompute the projection matrix 40 at least in part by performing QR decomposition 90 on a product 91 of the gradient 32 and the projection matrix 40. In contrast to the projected gradient 42, this product 91 is computed using the projection matrix 40 from a previous gradient descent iteration. The one or more processing devices 12 are therefore configured to obtain an orthogonal matrix 92 according to the following equation:

$$Q = QR ( {G}_{t} {P}_{t - 1} )$$

The one or more processing devices 12 are further configured to compute a product 94 of the orthogonal matrix 92 transposed and the gradient 32. In addition, the one or more processing devices 12 are further configured to compute an SVD 96 of the product 94. The SVD 96 may output the following matrices:

$$U , \sum , {P}_{t}^{T} = SVD ( {Q}^{T} {G}_{t} )$$

The one or more processing devices 12 are further configured to recompute the projection matrix 40 based at least in part on the SVD 96. In the example of FIG. 5, the one or more processing devices 12 are configured to obtain the recomputed projection matrix 82 by transposing the matrix

$${P}_{t}^{T}$$

computed as one of the outputs of the SVD 96.

The recomputation shown in FIG. 5 has a computational complexity of [symbol] (mr²), where m is the number of rows included in the weight tensor 22 and r is the rank of the reduced-rank subspace 38. In contrast, the SVD-based projection matrix recomputation used in GaLore has a computational complexity of [symbol] (mn²). The recomputation of the projection matrix 40 is accordingly sped up by a factor of

$$\frac{{n}^{2}}{{r}^{2}}$$

compared to GaLore.

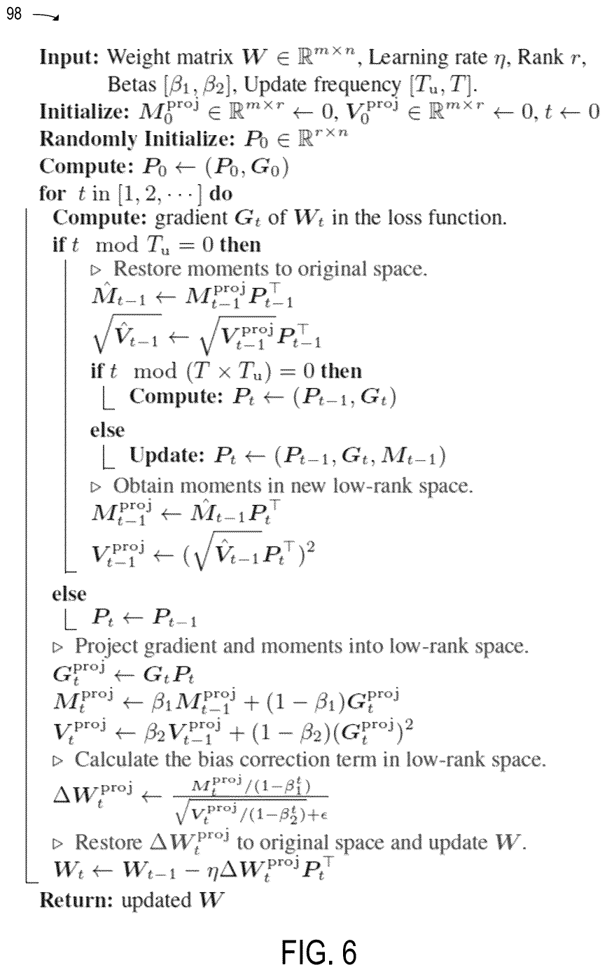

FIG. 6 shows pseudocode of an algorithm 98 by which the weight tensor 22 may be updated to train the neural network 20. The algorithm 98 is an Adam optimizer that has been modified to use the projection matrix updating techniques discussed above with reference to FIGS. 1-5. Accordingly, the amount of memory used to store the optimizer state is reduced relative to full-rank projection. In addition, the computational complexity of updating the projection matrix 40 is decreased relative to previous approaches.

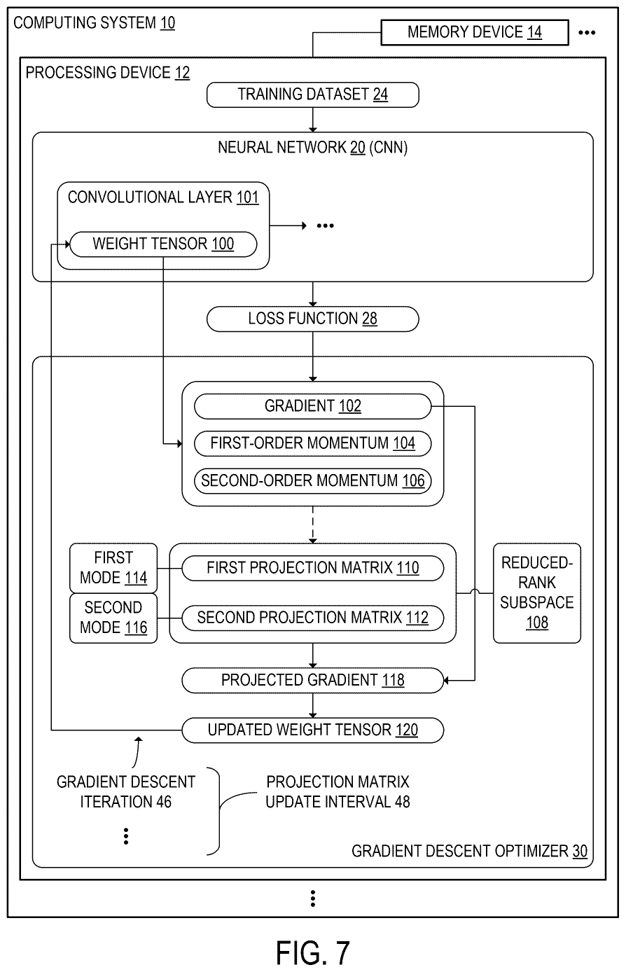

FIG. 7 schematically shows the computing system 10 in an example in which a weight tensor 100 is included in a convolutional layer 101 of the neural network 20. In such examples, the weight tensor 100 may have dimensions [symbol] ∈ [symbol] ^{O×I×K}^{₁}^{×K}^{₂}, where O is a number of output channels of the convolutional layer 100, I is a number of input channels, K₁ is a first kernel size, and K₂ is a second kernel size.

In the example of FIG. 7, The one or more processing devices 12 are configured to compute a first projection matrix 110 and a second projection matrix 112 in each of the projection matrix update intervals 48. The first projection matrix 110 encodes a projection of a first mode 114 of the weight tensor 100 and the second projection matrix 112 encodes a projection of a second mode 116 of the weight tensor 100. The first mode 114 and the second mode 116 may respectively be the output channel dimension and the input channel dimension of the weight tensor 100.

The one or more processing devices 12 are further configured to compute a gradient 102, a first-order momentum 104, and a second-order momentum 106. The one or more processing devices 12 are further configured to project the gradient 102 into a reduced-rank subspace 108 using the first projection matrix 110 and the second projection matrix 112. Thus, the one or more processing devices 12 are configured to compute a projected gradient 118. The one or more processing devices 12 are further configured to compute an updated weight tensor 120 by updating the weight tensor 22 based at least in part on the projected gradient 118.

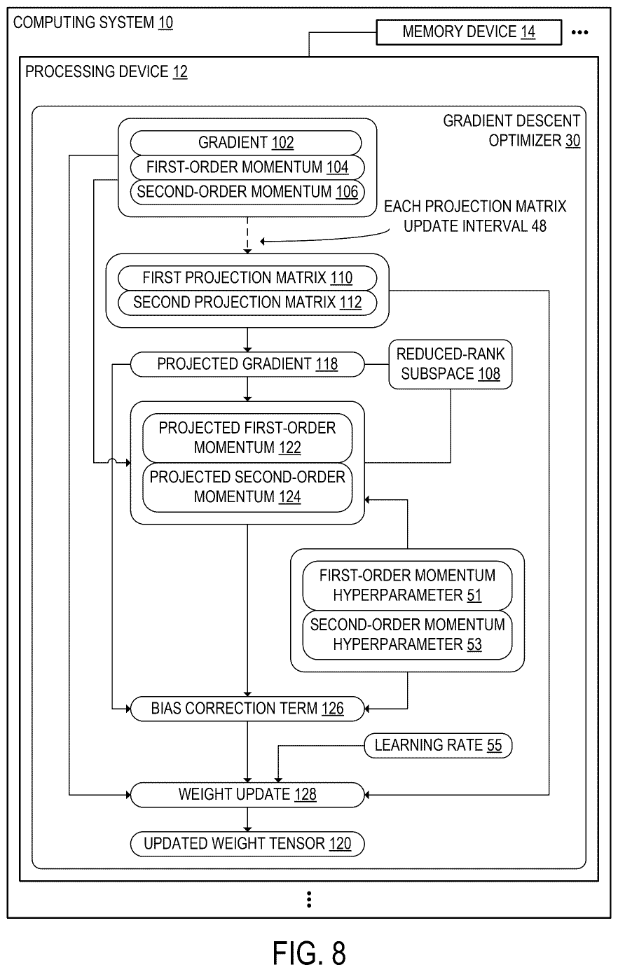

FIG. 8 shows the computing system 10 in additional detail when the one or more processing devices 12 compute the updated weight tensor 120. The one or more processing devices 12 may be configured to project the gradient 32 into the reduced-rank subspace 108 at least in part by multiplying the weight tensor 100 by the first projection matrix 110 transposed and the second projection matrix 112 transposed. The projected gradient 118 may accordingly be computed according to the following equation:

$${\hat{𝒢}}_{t}^{proj} = {𝒢}_{t} {\times }_{1} {P}_{{1}_{t}}^{T} {\times }_{2} {P}_{{2}_{t}}^{T}$$

In the above equation, [symbol] ₜ is the gradient 32,

$${P}_{{1}_{t}}^{T}$$

is the first projection matrix 110 transposed,

$${P}_{{2}_{t}}^{T}$$

is the second projection matrix 112 transposed, ×₁ is a product along the first mode 114, and ×₂ is a product along the second mode 116.

The one or more processing devices 12 are further configured to compute a projected first-order momentum 122 and a projected second-order momentum 124 based at least in part on the projected gradient 118. For example, the projected first-order momentum 122 and the projected second-order momentum 124 may be computed using the equations for the projected first-order momentum 50 and the projected second-order momentum 52 discussed above with reference to the example of FIG. 2, but with the projected gradient 118 instead of the projected gradient 42.

The one or more processing devices 12 are further configured to compute a bias correction term 126 based at least in part on the projected gradient 118, the projected first-order momentum 122, the projected second-order momentum 124, the first-order momentum hyperparameter 51, and the second-order momentum hyperparameter 53. In the example of FIG. 8, the bias correction term 126 may be computed as in the example of FIG. 2. The one or more processing devices 12 are further configured to compute a weight update 128 based at least in part on the bias correction term 126, the learning rate 55, the first projection matrix 110, and the second projection matrix 112. By applying the weight update 128 to weight tensor 100, the one or more processing devices 12 are further configured to compute the updated weight tensor 120.

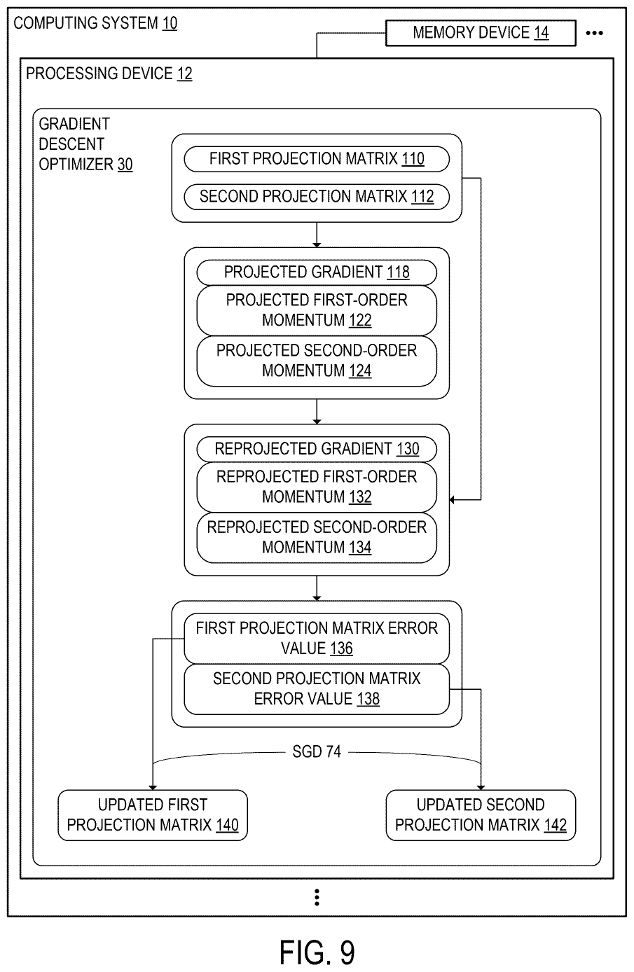

FIG. 9 schematically shows the computing system 10 when the first projection matrix 110 and the second projection matrix 112 are updated. During each of the projection matrix update iterations 48, the one or more processing devices 12 are further configured to compute a reprojected gradient 130, a reprojected first-order momentum 132, and a reprojected second-order momentum 134. The reprojected gradient 130 may be computed according to the following equation:

$${\hat{𝒢}}_{t} = {\hat{𝒢}}_{t}^{proj} {\times }_{1} {P}_{{1}_{t}} {\times }_{2} {P}_{{2}_{t}}$$

The one or more processing devices 12 are further configured to compute a first projection matrix error value 136 associated with the first projection matrix 110 and compute a second projection matrix error value 138 associated with the second projection matrix 112. The one or more processing devices 12 are further configured to update the first projection matrix 110 based at least in part on the first projection matrix error value 136 and update the second projection matrix 112 based at least in part on the second projection matrix error value 138. When updating the projection matrices, the one or more processing devices 12 may be configured to perform SGD 74 with respect to the first projection matrix error value 136 and the second projection matrix error value 138 to compute an updated first projection matrix 140 and an updated second projection matrix 142.

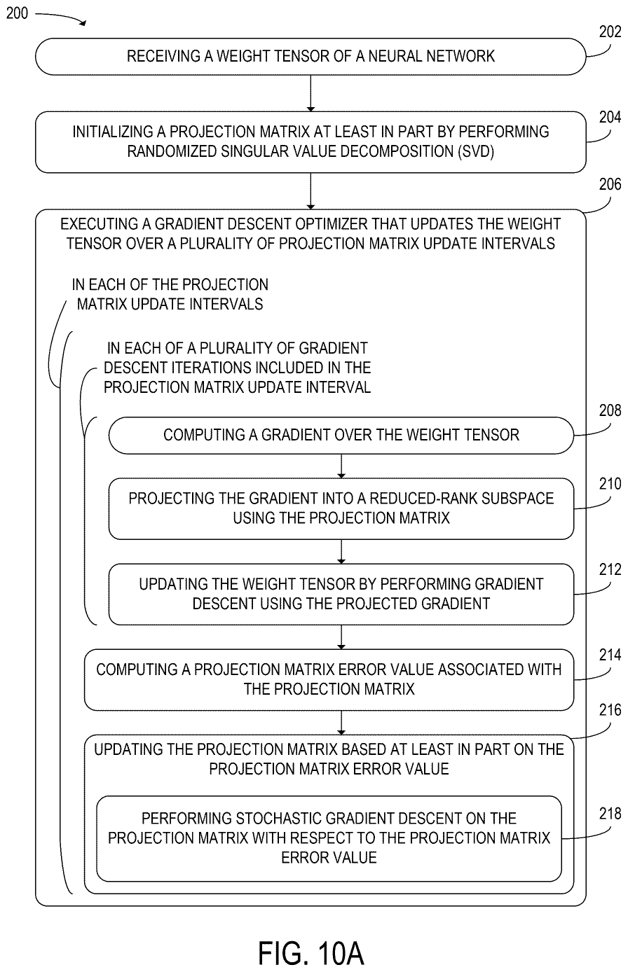

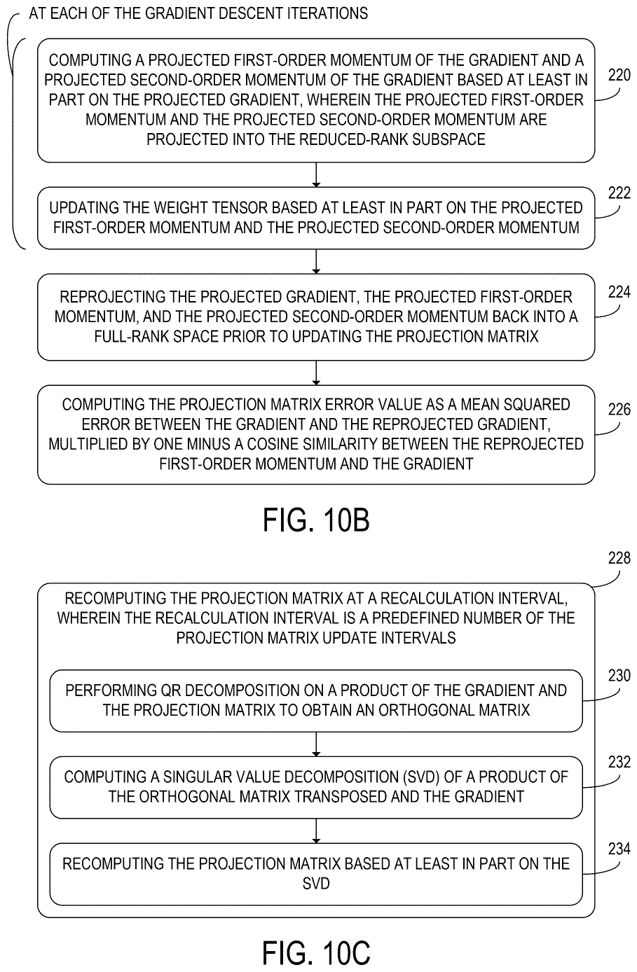

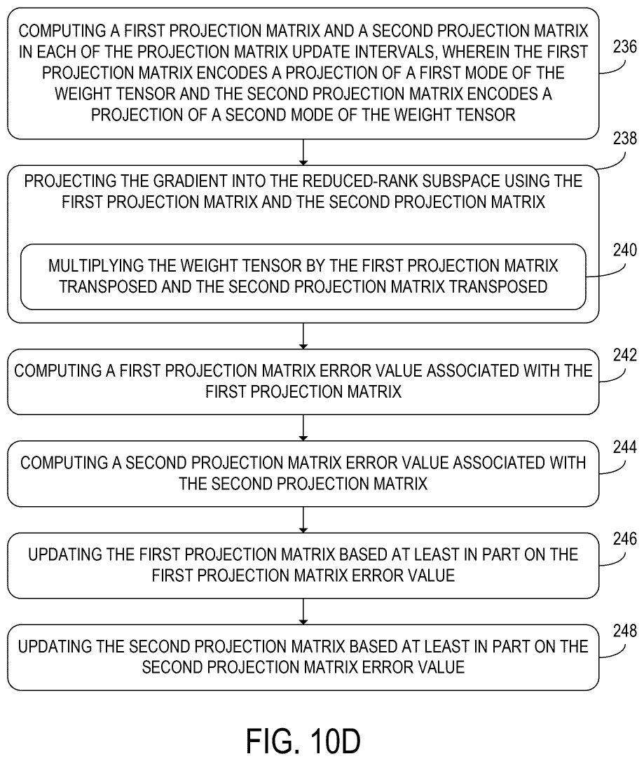

FIG. 10A shows a flowchart of a method 200 for use with a computing system when training a neural network. At step 202, the method 200 includes receiving a weight tensor of a neural network. The weight tensor may be a matrix or a higher-order tensor.

In some examples, at step 204, the method 200 may further include initializing a projection matrix at least in part by performing randomized singular value decomposition (SVD). Randomized SVD results in a projection matrix that applies a projection from a full-rank space to a randomized reduced-rank subspace. The projection matrix is initialized prior to a plurality of projection matrix update intervals.

At step 206, the method 200 further includes executing a gradient descent optimizer that updates the weight tensor over a plurality of projection matrix update intervals. Each of the projection matrix update intervals includes a plurality of gradient descent iterations. In each of the gradient descent iterations included in the projection matrix update interval, step 206 further includes, at step 208, computing a gradient over the weight tensor. This gradient is computed as the gradient of a loss function or reward function with respect to the elements of the weight tensor. The loss values or reward values that are used to compute the gradient at respective gradient descent iterations may be obtained from forward passes of respective batches of training data through the neural network.

At step 210, step 206 further includes, in each of the gradient descent iterations, projecting the gradient into a reduced-rank subspace using a projection matrix. At step 212, in each of the gradient descent iterations, step 206 further includes updating the weight tensor by performing gradient descent using the projected gradient. The neural network may therefore be trained in each of the gradient descent iterations according to the gradient of the loss function or reward function.

At step 214, in each of the projection matrix update intervals, step 206 further includes computing a projection matrix error value associated with the projection matrix. Step 214 is performed subsequently to performing the plurality of gradient descent iterations included in the projection matrix update interval. At step 216, in each of the projection matrix update intervals, step 206 further includes updating the projection matrix based at least in part on the projection matrix error value. The projection matrix may accordingly be updated at an interval specified as a predefined number of gradient descent iterations. In some examples, at step 218, updating the projection matrix at step 216 includes performing stochastic gradient descent on the projection matrix with respect to the projection matrix error value.

FIG. 10B shows additional steps of the method 200 that may be performed in some examples in each of the projection matrix update intervals. Step 220 and step 222 may be performed at each of the gradient descent iterations. At step 220, the method 200 may further include computing a projected first-order momentum of the gradient and a projected second-order momentum of the gradient based at least in part on the projected gradient. The projected first-order momentum and the projected second-order momentum are projected into the reduced-rank subspace. Projecting the first-order momentum and the second-order momentum into the reduced-rank subspace decreases the amount of memory used to store the first-order momentum and the second-order momentum.

At step 222, the method 200 may further include updating the weight tensor based at least in part on the projected first-order momentum and the projected second-order momentum. Performing step 222 may include computing a bias correction term based at least in part on the projected first-order momentum, the projected second-order momentum, a first-order momentum hyperparameter, and a second-order momentum hyperparameter. Updating the weight tensor at step 222 may further include computing a weight update based at least in part on the bias correction term, the projection matrix, and a learning rate, and applying that weight update to the weight tensor.

Step 224 may be performed in each of the projection matrix update intervals subsequently to the plurality of gradient descent iterations. At step 224, the method 200 may further include reprojecting the projected gradient, the projected first-order momentum, and the projected second-order momentum back into a full-rank space. The projected gradient, the projected first-order momentum, and the projected second-order momentum are reprojected prior to updating the projection matrix.

Step 226 may be performed in some examples when computing the projection matrix error value at step 214. At step 226, the method 200 may further include computing the projection matrix error value as a mean squared error between the gradient and the reprojected gradient, multiplied by one minus a cosine similarity between the reprojected first-order momentum and the gradient.

FIG. 10C shows additional steps of the method 200 that may be performed in some examples during the execution of the gradient descent optimizer at step 206. At step 228, the method 200 may further include recomputing the projection matrix at a recalculation interval. The recalculation interval is a predefined number of the projection matrix update intervals. Recomputing the projection matrix, in addition to making smaller adjustments to the projection matrix at step 216, may account for differences in the gradient direction associated with different portions of the training dataset, and may therefore increase the convergence rate of training.

Recomputing the projection matrix at step 228 may include, at step 230, performing QR decomposition on a product of the gradient and the projection matrix to obtain an orthogonal matrix. At step 232, step 228 may further include computing an SVD of a product of the orthogonal matrix transposed and the gradient. At step 234, step 228 may further include recomputing the projection matrix based at least in part on the SVD. The projection matrix is accordingly recomputed to have a reduced-rank subspace that approximates the direction of the gradient.

FIG. 10D shows additional steps of the method 200 that may be performed in examples in which the weight tensor is included in a convolutional layer of the neural network. In such examples, the weight tensor may be a four-tensor with modes that correspond to an output channel, an input channel, a first kernel dimension, and a second kernel dimension of the convolutional layer. At step 236, the method 200 may further include computing a first projection matrix and a second projection matrix in each of the projection matrix update intervals. The first projection matrix may encode a projection of a first mode of the weight tensor and the second projection matrix may encode a projection of a second mode of the weight tensor.

At step 238, the method 200 may further include projecting the gradient into the reduced-rank subspace using the first projection matrix and the second projection matrix. For example, at step 240, step 238 may include multiplying the weight tensor by the first projection matrix transposed and the second projection matrix transposed. Step 238 may be performed in each of the gradient descent iterations.

Steps 242, 244, 246, and 248 may be performed in each of the projection matrix update iterations. At step 242, the method 200 may further include computing a first projection matrix error value associated with the first projection matrix 242. In addition, at step 244, the method 200 may further include computing a second projection matrix error value associated with the second projection matrix. At step 246, the method 200 may further include updating the first projection matrix based at least in part on the first projection matrix error value. In addition, at step 248, the method 200 may further include updating the second projection matrix based at least in part on the second projection matrix error value. The first projection matrix and the second projection matrix may be updated by performing SGD with respect to the first projection matrix error value and the second projection matrix error value.

Using the systems and methods discussed above, a computing system is configured to train a neural network using a gradient descent optimizer that projects the gradient into a reduced-rank subspace using a projection matrix. This projection is also performed on a first-order momentum and a second-order momentum included in the optimizer state. By projecting the optimizer state, the computing system reduces the amount of memory (e.g., GPU memory) that the optimizer state occupies.

The gradient descent optimizer discussed above periodically updates the projection matrix according to a projection matrix error value. Compared to previous gradient descent optimizers that use projection matrices, the gradient descent optimizer discussed above accurately matches the reduced-rank subspace to the gradient direction, thereby achieving a faster convergence rate. The gradient descent optimizer also performs projection matrix updating with low computational complexity. The systems and methods discussed above may therefore train the neural network more quickly and with reduced memory consumption relative to previous approaches.

The methods and processes described herein are tied to a computing system of one or more computing devices. In particular, such methods and processes can be implemented as a computer-application program or service, an application-programming interface (API), a library, and/or other computer-program product.

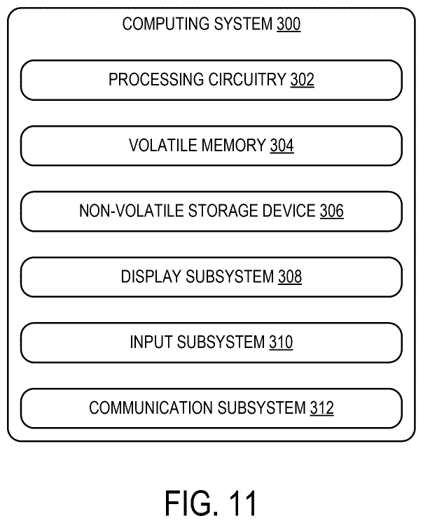

FIG. 11 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 11.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. Non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. Volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional description of the subject matter of the present disclosure. According to one aspect of the present disclosure, a computing system is provided, including one or more processing devices configured to receive a weight tensor of a neural network. The one or more processing devices may be further configured to execute a gradient descent optimizer that updates the weight tensor over a plurality of projection matrix update intervals. Each of the projection matrix update intervals includes, in each of a plurality of gradient descent iterations included in the projection matrix update interval, computing a gradient over the weight tensor. Each of the gradient descent iterations further includes projecting the gradient into a reduced-rank subspace using a projection matrix. Each of the gradient descent iterations further includes updating the weight tensor by performing gradient descent using the projected gradient. Each of the projection matrix update intervals further includes computing a projection matrix error value associated with the projection matrix. Each of the projection matrix update intervals further includes updating the projection matrix based at least in part on the projection matrix error value. The above features may have the technical effect of projecting the gradient during neural network training in a manner that has low memory usage and low computational complexity.

According to this aspect, the one or more processing devices may be configured to update the projection matrix at least in part by performing stochastic gradient descent on the projection matrix with respect to the projection matrix error value. The above features may have the technical effect of computing a projection matrix that accurately matches the direction of the gradient.

According to this aspect, at each of the gradient descent iterations, the one or more processing devices may be further configured to compute a projected first-order momentum of the gradient and a projected second-order momentum of the gradient based at least in part on the projected gradient. The projected first-order momentum and the projected second-order momentum are projected into the reduced-rank subspace. The one or more processing devices may be further configured to update the weight tensor based at least in part on the projected first-order momentum and the projected second-order momentum. The above features may have the technical effect of reducing the amount of memory used to store the first-order momentum and the second-order momentum.

According to this aspect, the one or more processing devices may be further configured to reproject the projected gradient, the projected first-order momentum, and the projected second-order momentum back into a full-rank space prior to updating the projection matrix. The above features may have the technical effect of allowing the projection matrix and the momenta to be updated using full-rank versions of the projected gradient, the projected first-order momentum, and the projected second-order momentum.

According to this aspect, the one or more processing devices may be configured to compute the projection matrix error value as a mean squared error between the gradient and the reprojected gradient, multiplied by one minus a cosine similarity between the reprojected first-order momentum and the gradient. The above features may have the technical effect of computing the projection matrix error value.

According to this aspect, the one or more processing devices may be further configured to recompute the projection matrix at a recalculation interval. The recalculation interval may be a predefined number of the projection matrix update intervals. The above features may have the technical effect of periodically recomputing the projection matrix to account for large changes in the gradient direction between different stages of neural network training.

According to this aspect, the one or more processing devices may be configured to recompute the projection matrix at least in part by performing QR decomposition on a product of the gradient and the projection matrix to obtain an orthogonal matrix. Recomputing the projected matrix may further include computing a singular value decomposition (SVD) of a product of the orthogonal matrix transposed and the gradient. Recomputing the projected matrix may further include recomputing the projection matrix based at least in part on the SVD. The above features may have the technical effect of generating a recomputed projection matrix that approximates the direction of the gradient.

According to this aspect, the weight tensor may be included in a convolutional layer of the neural network. The one or more processing devices may be configured to compute a first projection matrix and a second projection matrix in each of the projection matrix update intervals. The first projection matrix may encode a projection of a first mode of the weight tensor and the second projection matrix may encode a projection of a second mode of the weight tensor. The one or more processing devices may be further configured to project the gradient into the reduced-rank subspace using the first projection matrix and the second projection matrix. The above features may have the technical effect of projecting a gradient with respect to a convolutional layer into a reduced-rank subspace.

According to this aspect, the one or more processing devices may be configured to project the gradient into the reduced-rank subspace at least in part by multiplying the weight tensor by the first projection matrix transposed and the second projection matrix transposed. The above features may have the technical effect of projecting the gradient into the reduced-rank subspace.

According to this aspect, during each of the projection matrix update iterations, the one or more processing devices may be further configured to compute a first projection matrix error value associated with the first projection matrix. The one or more processing devices may be further configured to compute a second projection matrix error value associated with the second projection matrix. The one or more processing devices may be further configured to update the first projection matrix based at least in part on the first projection matrix error value and update the second projection matrix based at least in part on the second projection matrix error value. The above features may have the technical effect of updating the projection matrices that are used with the convolutional layer.

According to this aspect, prior to the plurality of projection matrix update intervals, the one or more processing devices may be further configured to initialize the projection matrix at least in part by performing randomized singular value decomposition (SVD). The above features may have the technical effect of computing an initial value of the projection matrix.

According to another aspect of the present disclosure, a method for use with a computing system is provided. The method includes receiving a weight tensor of a neural network. The method further includes executing a gradient descent optimizer that updates the weight tensor over a plurality of projection matrix update intervals. Each of the projection matrix update intervals includes, in each of a plurality of gradient descent iterations included in the projection matrix update interval, computing a gradient over the weight tensor. Each of the gradient descent iterations further includes projecting the gradient into a reduced-rank subspace using a projection matrix. Each of the gradient descent iterations further includes updating the weight tensor by performing gradient descent using the projected gradient. Each of the projection matrix update intervals further includes computing a projection matrix error value associated with the projection matrix. Each of the projection matrix update intervals further includes updating the projection matrix based at least in part on the projection matrix error value. The above features may have the technical effect of projecting the gradient during neural network training in a manner that has low memory usage and low computational complexity.

According to this aspect, updating the projection matrix may include performing stochastic gradient descent on the projection matrix with respect to the projection matrix error value. The above features may have the technical effect of computing a projection matrix that accurately matches the direction of the gradient.

According to this aspect, at each of the gradient descent iterations, the method may further include computing a projected first-order momentum of the gradient and a projected second-order momentum of the gradient based at least in part on the projected gradient. The projected first-order momentum and the projected second-order momentum may be projected into the reduced-rank subspace. The method may further include updating the weight tensor based at least in part on the projected first-order momentum and the projected second-order momentum. The above features may have the technical effect of reducing the amount of memory used to store the first-order momentum and the second-order momentum.

According to this aspect, the method may further include reprojecting the projected gradient, the projected first-order momentum, and the projected second-order momentum back into a full-rank space prior to updating the projection matrix. The above features may have the technical effect of allowing the projection matrix and the momenta to be updated using full-rank versions of the projected gradient, the projected first-order momentum, and the projected second-order momentum.

According to this aspect, the method may further include recomputing the projection matrix at a recalculation interval. The recalculation interval may be a predefined number of the projection matrix update intervals. The above features may have the technical effect of periodically recomputing the projection matrix to account for large changes in the gradient direction between different stages of neural network training.

According to this aspect, recomputing the projection matrix may include performing QR decomposition on a product of the gradient and the projection matrix to obtain an orthogonal matrix. Recomputing the projection matrix may further include computing a singular value decomposition (SVD) of a product of the orthogonal matrix transposed and the gradient. The projection matrix may be recomputed based at least in part on the SVD. The above features may have the technical effect of generating a recomputed projection matrix that approximates the direction of the gradient.

According to this aspect, the weight tensor may be included in a convolutional layer of the neural network. The method may further include computing a first projection matrix and a second projection matrix in each of the projection matrix update intervals. The first projection matrix may encode a projection of a first mode of the weight tensor and the second projection matrix may encode a projection of a second mode of the weight tensor. The method may further include projecting the gradient into the reduced-rank subspace using the first projection matrix and the second projection matrix. The above features may have the technical effect of projecting a gradient with respect to a convolutional layer into a reduced-rank subspace.

According to this aspect, prior to the plurality of projection matrix update intervals, the method may further include initializing the projection matrix at least in part by performing randomized singular value decomposition (SVD). The above features may have the technical effect of computing an initial value of the projection matrix.

According to another aspect of the present disclosure, a computing system is provided, including one or more processing devices configured to receive a weight tensor included in a convolutional layer of a neural network. The one or more processing devices are further configured to execute a gradient descent optimizer that updates the weight tensor over a plurality of projection matrix update intervals. Each of the projection matrix update intervals includes, in each of a plurality of gradient descent iterations included in the projection matrix update interval, computing a gradient over the weight tensor. Each of the gradient descent iterations further includes projecting the gradient into a reduced-rank subspace using a first projection matrix and a second projection matrix. Each of the gradient descent iterations further includes updating the weight tensor by performing gradient descent using the projected gradient. Each of the projection matrix update intervals further includes computing a first projection matrix error value associated with the first projection matrix. Each of the projection matrix update intervals further includes computing a second projection matrix error value associated with the second projection matrix. Each of the projection matrix update intervals further includes updating the first projection matrix based at least in part on the first projection matrix error value and updating the second projection matrix based at least in part on the second projection matrix error value. The above features may have the technical effect of projecting the gradient during neural network training in a manner that has low memory usage and low computational complexity. “And/or” as used herein is defined as the inclusive or V, as specified by

the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein. as well as any and all equivalents thereof.

1. A computing system comprising:
one or more processing devices configured to:
receive a weight tensor of a neural network; and
execute a gradient descent optimizer that updates the weight tensor over a plurality of projection matrix update intervals, wherein each of the projection matrix update intervals includes:
in each of a plurality of gradient descent iterations included in the projection matrix update interval:
computing a gradient over the weight tensor;
projecting the gradient into a reduced-rank subspace using a projection matrix; and
updating the weight tensor by performing gradient descent using the projected gradient;
computing a projection matrix error value associated with the projection matrix; and
updating the projection matrix based at least in part on the projection matrix error value.

2. The computing system of claim 1, wherein the one or more processing devices are configured to update the projection matrix at least in part by performing stochastic gradient descent on the projection matrix with respect to the projection matrix error value.

3. The computing system of claim 1, wherein, at each of the gradient descent iterations, the one or more processing devices are further configured to:
compute a projected first-order momentum of the gradient and a projected second-order momentum of the gradient based at least in part on the projected gradient, wherein the projected first-order momentum and the projected second-order momentum are projected into the reduced-rank subspace; and
update the weight tensor based at least in part on the projected first-order momentum and the projected second-order momentum.

4. The computing system of claim 3, wherein the one or more processing devices are further configured to reproject the projected gradient, the projected first-order momentum, and the projected second-order momentum back into a full-rank space prior to updating the projection matrix.

5. The computing system of claim 4, wherein the one or more processing devices are configured to compute the projection matrix error value as:
a mean squared error between the gradient and the reprojected gradient, multiplied by one minus a cosine similarity between the reprojected first-order momentum and the gradient.

6. The computing system of claim 1, wherein:
the one or more processing devices are further configured to recompute the projection matrix at a recalculation interval; and
the recalculation interval is a predefined number of the projection matrix update intervals.

7. The computing system of claim 6, wherein the one or more processing devices are configured to recompute the projection matrix at least in part by:
performing QR decomposition on a product of the gradient and the projection matrix to obtain an orthogonal matrix;
computing a singular value decomposition (SVD) of a product of the orthogonal matrix transposed and the gradient; and
recomputing the projection matrix based at least in part on the SVD.

8. The computing system of claim 1, wherein:
the weight tensor is included in a convolutional layer of the neural network; and
the one or more processing devices are configured to:
compute a first projection matrix and a second projection matrix in each of the projection matrix update intervals, wherein the first projection matrix encodes a projection of a first mode of the weight tensor and the second projection matrix encodes a projection of a second mode of the weight tensor; and
project the gradient into the reduced-rank subspace using the first projection matrix and the second projection matrix.

9. The computing system of claim 8, wherein the one or more processing devices are configured to project the gradient into the reduced-rank subspace at least in part by multiplying the weight tensor by the first projection matrix transposed and the second projection matrix transposed.

10. The computing system of claim 8, wherein, during each of the projection matrix update iterations, the one or more processing devices are further configured to:
compute a first projection matrix error value associated with the first projection matrix;
compute a second projection matrix error value associated with the second projection matrix;
update the first projection matrix based at least in part on the first projection matrix error value; and
update the second projection matrix based at least in part on the second projection matrix error value.

11. The computing system of claim 1, wherein, prior to the plurality of projection matrix update intervals, the one or more processing devices are further configured to initialize the projection matrix at least in part by performing randomized singular value decomposition (SVD).

12. A method for use with a computing system, the method comprising:
receiving a weight tensor of a neural network; and
executing a gradient descent optimizer that updates the weight tensor over a plurality of projection matrix update intervals, wherein each of the projection matrix update intervals includes:
in each of a plurality of gradient descent iterations included in the projection matrix update interval:
computing a gradient over the weight tensor;
projecting the gradient into a reduced-rank subspace using a projection matrix; and
updating the weight tensor by performing gradient descent using the projected gradient;
computing a projection matrix error value associated with the projection matrix; and
updating the projection matrix based at least in part on the projection matrix error value.

13. The method of claim 12, wherein updating the projection matrix includes performing stochastic gradient descent on the projection matrix with respect to the projection matrix error value.

14. The method of claim 12, further comprising, at each of the gradient descent iterations:
computing a projected first-order momentum of the gradient and a projected second-order momentum of the gradient based at least in part on the projected gradient, wherein the projected first-order momentum and the projected second-order momentum are projected into the reduced-rank subspace; and
updating the weight tensor based at least in part on the projected first-order momentum and the projected second-order momentum.

15. The method of claim 14, further comprising reprojecting the projected gradient, the projected first-order momentum, and the projected second-order momentum back into a full-rank space prior to updating the projection matrix.

16. The method of claim 12, further comprising recomputing the projection matrix at a recalculation interval, wherein the recalculation interval is a predefined number of the projection matrix update intervals.

17. The method of claim 16, wherein recomputing the projection matrix includes:
performing QR decomposition on a product of the gradient and the projection matrix to obtain an orthogonal matrix;
computing a singular value decomposition (SVD) of a product of the orthogonal matrix transposed and the gradient; and
recomputing the projection matrix based at least in part on the SVD.

18. The method of claim 12, wherein:
the weight tensor is included in a convolutional layer of the neural network; and
the method further comprises:
computing a first projection matrix and a second projection matrix in each of the projection matrix update intervals, wherein the first projection matrix encodes a projection of a first mode of the weight tensor and the second projection matrix encodes a projection of a second mode of the weight tensor; and
projecting the gradient into the reduced-rank subspace using the first projection matrix and the second projection matrix.

19. The method of claim 12, wherein, prior to the plurality of projection matrix update intervals, the method further comprises initializing the projection matrix at least in part by performing randomized singular value decomposition (SVD).

20. A computing system comprising:
one or more processing devices configured to:
receive a weight tensor included in a convolutional layer of a neural network; and
execute a gradient descent optimizer that updates the weight tensor over a plurality of projection matrix update intervals, wherein each of the projection matrix update intervals includes:
in each of a plurality of gradient descent iterations included in the projection matrix update interval:
computing a gradient over the weight tensor;
projecting the gradient into a reduced-rank subspace using a first projection matrix and a second projection matrix; and
updating the weight tensor by performing gradient descent using the projected gradient;
computing a first projection matrix error value associated with the first projection matrix;
computing a second projection matrix error value associated with the second projection matrix;
updating the first projection matrix based at least in part on the first projection matrix error value; and
updating the second projection matrix based at least in part on the second projection matrix error value.
